(19) United States
(12) Patent Application Publication
(10) Pub. No.: US 2005/0168977 A1
(43) Pub. Date: Aug. 4, 2005

(54) Self-powered lighting fixture

(76) Inventor: John J. Murphy, Freehold, NJ (US)

Correspondence Address: OSTROLENK FABER GERB & SOFFEN, 1180 AVENUE OF THE AMERICAS, NEW YORK, NY, 100368403, US

(21) Appl. No.: 11/050,583

(22) Filed: Feb. 3, 2005

Related U.S. Application Data
(60) Provisional application No. 60/541,973, filed on Feb. 4, 2004.

(51) Int. Cl. F21L 4/00

(52) U.S. Cl. 362/191

(57) ABSTRACT

A self-powered lighting fixture comprising a support member; at least one light-emitting diode adapted to be coupled to a self-contained power source; the support member having a location for supporting the self-contained power source thereon; an electrical connection interconnecting the power source to the at least one light-emitting diode; an on/off switch included in the electrical connection for turning the at least one light-emitting diode on and off as desired by a user; and an optical member for transmitting or directing light energy radiated by the at least one light-emitting diode.

### CROSS-REFERENCE TO RELATED APPLICATIONS

The present invention claims the benefit and priority of a provisional patent application Ser. No. 60/541,973 filed Feb. 4, 2004 entitled SELF-POWERED LIGHTING FIXTURE, the entire disclosure of which is hereby incorporated by reference.

### BACKGROUND OF THE INVENTION

The present invention relates to lighting fixtures, and in particular, to self-powered lighting fixtures, and more particularly, to a self-powered lighting fixture that employs light-emitting diodes as the illumination source.

In recent years, light-emitting diodes have been developed which provide greater illumination capability. Light-emitting diodes have significant advantages including that they are relatively energy efficient, having lower current drains than other lighting sources such as incandescent lamps. Further, they are longer lasting than incandescent lamps and thus do not need to be replaced as often. Furthermore, they are available in various colors, including white and other colors, thereby allowing their use in varying applications and allowing achievement of various lighting effects.

However, light-emitting diodes have not been practically used for home lighting, and in particular, have not been used in home lighting that is self-powered, i.e., powered by suitable batteries or other self-contained power sources.

### SUMMARY OF THE INVENTION

It is accordingly an object of the present invention to provide a self-powered lighting fixture which can be used in the home or other building structure, for example, as a wall sconce or ceiling fixture to provide illumination.

It is yet a further object of the present invention to provide a self-contained lighting fixture that is battery powered and that employs light-emitting diodes as the illumination source.

It is furthermore an object of the present invention to provide a self-contained lighting fixture that will provide a long usage time from a battery with a disposable or a rechargeable battery.

It is furthermore an object of the present invention to provide a self-contained lighting fixture which does not require connection to a building's electrical power network, thus allowing its installation by virtually anyone at any location in or on a building, for example on a wall, ceiling and either at internal or external locations, and which thus does not require any alteration of the building's electrical system or structure.

The above and other objects of the present invention are achieved by a self-powered lighting fixture comprising: a support member; at least one light-emitting diode adapted to be coupled to a self-contained power source; the support member having a location for supporting the self-contained power source thereon; an electrical connection interconnecting the power source to the at least one light-emitting diode; an on/off switch included in the electrical connection for turning the at least one light-emitting diode on and off as desired by a user; and an optical member for transmitting or directing light energy radiated by the at least one light-emitting diode.

According to one embodiment, the present invention comprises a battery powered, self-contained lighting fixture, for example, a wall sconce, that provides illumination. The lighting fixture includes at least one light-emitting diode to provide an illumination source and a battery pack, which is replaceable and/or rechargeable, contained within the lighting fixture. The lighting fixture may comprise a first component comprising a support plate mountable on a building structural component such as a wall and a second component comprising a circuit board on which at least one light-emitting diode is disposed. A third component comprises a light transmitting member for diffusing and/or transmitting the light in a desired manner and for providing a pleasing ornamental appearance. Suitable wiring is provided between the light-emitting diode or diodes and the support plate. The circuit board contains the at least one light-emitting diode and suitable current limiting/voltage dropping resistors as required. An on/off switch may be provided on the support plate, on the circuit board or at any other location which would provide a convenient means for turning the at least one light-emitting diode on and off. Preferably, the on/off switch may be an on/off switch which provides a dimming function such as an on/off switch that also includes a high intensity and low intensity setting. Furthermore, the self-contained lighting fixture may also include a suitable dimming circuit to provide greater range of dimming capability, including a plurality of discrete dimming levels or dimming achievable over a continuous range.

The invention may also include a suitable remote control transmitter which transmits signals to the lighting fixture to control the on/off and dimming status of the lighting fixture. Accordingly, the circuit board will preferably also contain a receiver to receive the signals transmitted by the remote transmitter. The remote control function may be provided by any of well known techniques including radio frequency (RF), infrared frequency (IR) or ultrasonic energy, or any other technique, as known to those of skill in the art.

Preferably, the lighting fixture includes a battery compartment housing a battery or batteries which provide an appropriate power source to energize the at least one light-emitting diode for a desired period of time. The battery compartment can house replaceable single use batteries or rechargeable batteries or the battery pack itself could be replaced with a new battery pack or batteries in the battery pack recharged by a suitable charging source.

In one embodiment, the batteries in the battery pack or the entire battery pack can be removed and placed into a charging source for charging. According to another embodiment, the entire lighting fixture or the support member housing the battery pack can be removed from its mounting location and placed into the battery charger. In another embodiment, the charger itself can be built into the lighting fixture or the back plate for the lighting fixture and the lighting fixture can then be plugged into a suitable source of electric power, for example, a conventional AC electric wall receptacle, to recharge the batteries.

According to one embodiment, the battery source may comprise an alkaline, lithium or a rechargeable battery. Any other suitable batteries can be employed.

According to one embodiment, the LEDs provide white light but LEDs providing a different color or multiple colors can be employed depending on the consumers' preference or as preselected. Further, the lighting fixture may have an electric circuit programmed to select different ones of LEDs generating light at different frequencies and therefore different colors to provide various lighting effects.

A benefit of the invention is that it allows the lighting fixture to be installed by non-trained, non-licensed individuals who are not versed or competent in building construction or in connecting electrical fixtures to electrical power sources or in running and/or connecting electrical wires and/or electrical conduits, cables and electrical junction boxes. Furthermore, the present invention can be applied in existing structures without requiring new wiring or without retrofitting an electrical system of the building structure and without requiring modifying the building's structure. Since the lighting fixture is battery powered, it can be mounted at any convenient location on a wall or a ceiling or can even be used as a lighting fixture on a table top or wherever desirable without requiring any wiring or rewiring.

The application and utilization of the invention will allow a consumer to remodel or decorate a home or building structure without the cost or invasive procedure of running electric lines to power the lighting fixture. In addition, the present invention is desirable for consumers who rent and are not allowed to alter the building structure as well as to residents who live in older homes with walls and ceilings that they do not desire to alter or are difficult to alter, for example, plaster walls and ceilings. Many consumers who can run electrical lines are furthermore hesitant to do so because they do not have the matching paint and other materials to repair the damage to the building structure created by the holes needed for the electrical wiring and junction boxes. This product will serve this market.

According to one embodiment, alkaline, lithium or rechargeable batteries are used as the power source. Such batteries can power the light-emitting diodes for many hours, much longer than a typical incandescent lamp. Furthermore, LEDs last much longer than incandescent lamps and have a lifetime of approximately 10,000 hours.

Accordingly, the present invention has several aspects. According to one aspect it is a lighting fixture which utilizes light-emitting diodes as the illumination source and batteries as the power source, either single use or rechargeable.

According to another aspect, the lighting fixture comprises a mounting plate on which are attached a circuit board comprising the light-emitting diodes and a battery pack and which are covered by a front cover to provide an ornamental appearance and preferably a light transmission element for transmitting the light generated by the light-emitting diodes.

According to another aspect, the invention comprises a self-contained lighting source which can be mounted anywhere within or outside a building structure. According to one aspect, the lighting fixture can replace a conventional AC powered lighting fixture because the lighting fixture according to the invention can be screwed into or on an electrical junction box thereby to replace the AC powered lighting fixture. According to yet another aspect, the lighting fixture includes a built-in charger which can be plugged into a suitable power source to recharge the batteries. The built-in charger preferably includes a plug in line cord which plugs into the charger and into an AC wall outlet to recharge the battery. According to another embodiment, the charger is provided as a separate transformer/adaptor which can be plugged into an AC wall outlet to recharge the battery.

Other objects, features and advantages of the invention will now be described in greater detail in the following detailed description.

### BRIEF DESCRIPTION OF THE DRAWINGS

The invention will now be described in greater detail in the following detailed description in reference to the drawings in which:

FIG. 1 shows an isometric front view of one embodiment of the lighting fixture according to the invention;

FIG. 2 shows a side view of the lighting fixture; and

FIG. 3 shows a front view of the lighting fixture according to the present invention with the front cover removed showing the circuit board containing the light-emitting diodes and the battery pack.

### DETAILED DESCRIPTION OF PREFERRED EMBODIMENTS OF THE INVENTION

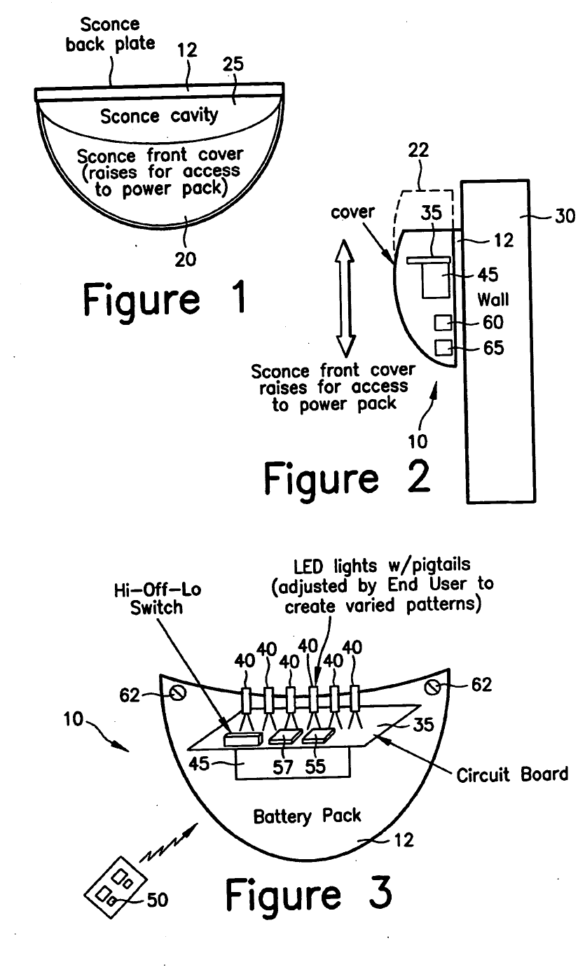

With reference now to the drawings, FIG. 1 shows a perspective front view of the lighting fixture 10 according to the present invention. The lighting fixture 10 has been embodied as a wall sconce, although it can take other forms. For example, the lighting fixture can be employed as a ceiling fixture. Furthermore, the lighting fixture can be disposed in interior or exterior locations. If in exterior locations, the lighting fixture will have suitable water proofing.

With reference to the drawing figure, the lighting fixture 10 includes a back plate support member 12 and a suitable cover 20. A circuit board 35 containing at least one LED 40 is fixed to the back plate 12. The at least one LED may comprise a high output or super bright LED. The cover 20 may be transparent or translucent, thereby allowing light energy from the light-emitting diode or diodes to be transmitted externally. The front cover 20 may comprise a suitable diffuser to provide a soft glow to the light emitted by the LEDs. It is also possible that the front cover 20 can be opaque in which case the lighting fixture provides indirect lighting through the open or light transmissible top portion 25.

With reference to FIG. 2 the lighting fixture is shown attached to a wall 30. The front cover 20 may be removable for obtaining access to the battery pack 45 and circuit board 35 by sliding it upwardly as shown by the dotted lines 22 or it can suitably snap on to the back plate 12 or attachment by any suitable means such as snap fasteners, screws or any other suitable attaching means. Contained within the sconce cavity as shown in FIG. 2 is the circuit board 35 containing one or more LEDs 40 as shown in detail in FIG. 3. Preferably below the circuit board, the battery pack or battery compartment 45 housing batteries is provided for powering the LEDs. The circuit board 35 contains any other necessary components to interconnect the LEDs to the battery pack, including any suitable voltage dropping/current limiting resistors as required. Furthermore, electrical wiring interconnects the battery pack to the circuit board containing the LEDs. Preferably, the battery pack 45 releasably connects via releasable electrical connections known to those of skill in the art to the circuit board 35 or to electrical wiring interconnecting the battery pack to the circuit board 35.

As shown in FIG. 3, the lighting fixture includes a suitable on/off switch, which may be disposed on the circuit board 35 or at some other location on the lighting fixture, for example, on the back plate 12 or on the front cover 20 or at any other suitable location, preferably on the fixture, in which case it will be interconnected by wires to the LEDs. The on/off switch need not be manually controllable, as it can be controlled by a remote control device, as described below. The on/off switch may be a controlled semiconductor switching device such as a transistor. As shown in FIG. 3, the on/off switch may comprise a switch having a plurality of settings, for example, a high intensity setting and a low intensity setting in addition to the off setting. Further, the lighting fixture may comprise a suitable light dimmer circuit, which provides a plurality of discrete or continuously variable light dimming settings. The dimming function can by provided by any suitable dimming circuit, including, for example, a circuit which pulse width modulates (PWM) the light-emitting diodes with a varying duty cycle to achieve a dimming effect.

Also shown in FIG. 3 is a remote control device 50 having suitable controls thereon and a transmitter for transmitting signals to the lighting fixture 10 to control the on/off and/or dimming status of the lighting fixture. The remote control 50 can operate by any known means such as radio frequency (RF), infrared frequency (IR) or ultrasonic frequency or any other suitable remote control transmission technique. The circuit board 35 preferably comprises a receiver 55 for receiving the signals transmitted by the remote control device 50.

The lighting fixture according to the present invention can also have a suitable photoelectric control 60 disposed thereon to enable the lighting fixture to be turned on automatically in darkness.

Furthermore, the light-emitting diodes 40 may radiate light at different frequencies to provide different colored lighting effects which can be selected as desired by the user or according to a preprogrammed pattern or sequence. The circuit for providing said preprogrammed pattern or sequence is preferably contained on circuit board 35 and is shown schematically at 57.

Alternatively, the LEDs 40 may have pigtails to allow selected ones of the LEDs of different colors to be connected into the circuit for providing user selected colors or color patterns.

The lighting fixture shown can, of course, take any shape and is not limited by the embodiment shown in the drawings. Furthermore, it can be mounted to or disposed on any surface, and is not limited to a wall mounting.

The back plate 12 has suitable means, for example, openings for screws 62, to enable it to be attached to a structural member of a building such as a building wall. Accordingly, any suitable means may be provided in the back plate to enable the lighting fixture to be attached to the building structure. For example, the back plate 12 can include suitable grooves or holes for allowing the back plate to be hung on a nail or other protruding object inserted into the building structure, for example, a nail or picture hanger nailed or screwed into a building wall.

Furthermore, the back plate may have suitable means to enable it to be attached to a conventional AC electrical junction box to replace a conventional AC powered fixture located at the electrical box.

FIG. 2 shows another aspect of the invention, a built-in charger 65 connected to the battery that can be plugged into a suitable power source to recharge the battery. The built-in charger 65 preferably includes a detachable plug in line cord which plugs into the charger 65 and into an AC wall outlet to recharge the battery. According to another embodiment, the charger is provided as a separate transformer/adaptor which can be plugged into an AC wall outlet to recharge the battery. The lighting fixture 10 includes an electrical jack to receive the electrical cord from the transformer/adaptor.

The present invention can also be used to modify or retrofit existing lighting fixtures, for example, those presently being manufactured that operate from household line current, to enable manufacturers to convert the lighting fixtures to battery power and LED illumination.

Although the present invention has been described in relation to particular embodiments thereof, many other variations and modifications and other uses will become apparent to those skilled in the art. Therefore, the present invention should be limited not by the specific disclosure herein, but only by the appended claims.

1. A self-powered lighting fixture comprising:
a support member;
at least one light-emitting diode adapted to be coupled to a self-contained power source;
the support member having a location for supporting the self-contained power source thereon;
an electrical connection interconnecting the power source to the at least one light-emitting diode;
an on/off switch included in the electrical connection for turning the at least one light-emitting diode on and off as desired by a user; and
an optical member for transmitting or directing light energy radiated by the at least one light-emitting diode.

2. The lighting fixture of claim 1, wherein the support member has an attaching fixture for attaching the support member to a structural member of a building.

3. The lighting fixture of claim 1, wherein the at least one light-emitting diode comprises a plurality of light-emitting diodes.

4. The lighting fixture of claim 1, further comprising at least one voltage dropping/current limiting resistor for the at least one light-emitting diode.

5. The lighting fixture of claim 1, wherein the location for the power source comprises a battery compartment for removably receiving at least one battery.

6. The lighting fixture of claim 1, wherein the location for the self-contained power source comprises releasable electrical connections for connecting to a battery.

7. The lighting fixture of claim 1, wherein the on/off switch comprises a mechanical switch.

8. The lighting fixture of claim 1, wherein the on/off switch has a plurality of settings, including high intensity, low intensity and off.

9. The lighting fixture of claim 1, further comprising a dimming circuit for dimming the at least one light-emitting diode.

10. The lighting fixture of claim 9, wherein the dimming circuit comprises a pulse width modulation circuit.

11. The lighting fixture of claim 1, wherein the on/off switch comprises a semiconductor switch.

12. The lighting fixture of claim 1, wherein the optical member comprises a transparent or translucent member.

13. The lighting fixture of claim 1, wherein the optical member is substantially opaque and directs light energy radiated by the at least one light-emitting diode through a light transmissible opening.

14. The lighting fixture of claim 1, wherein the optical member comprises a light diffuser.

15. The lighting fixture of claim 1, further comprising a remote control transmitter for controlling the on/off operation of the lighting fixture.

16. The lighting fixture of claim 15, further comprising a receiver receiving signals transmitted by the remote control transmitter to control the on/off operation of the lighting fixture.

17. The lighting fixture of claim 16, wherein the receiver also controls the dimming level of the at least one light-emitting diode.

18. The lighting fixture of claim 1, wherein the at least one light-emitting diode is mounted on a circuit board.

19. The lighting fixture of claim 1, wherein the at least one light-emitting diode comprises a plurality of light-emitting diodes radiating light of different colors.

20. The lighting fixture of claim 19, further comprising a circuit for controlling the plurality of light-emitting diodes to achieve a desired lighting effect.

21. The lighting fixture of claim 1, further comprising a photo-electric control for the lighting fixture.

22. The lighting fixture of claim 1, further comprising a charger for the self-contained power source.

23. The lighting fixture of claim 22, wherein the charger is disposed on the support member.

24. The lighting fixture of claim 22, wherein the charger is disposed outside the lighting fixture and releasably connectable to the lighting fixture by an electrical wire connection.

25. The lighting fixture of claim 1, wherein the self-contained power source comprises a replaceable or rechargeable battery.
